(19) United States
(12) Patent Application Publication
(10) Pub. No.: US 2017/0287091 A1
(43) Pub. Date: Oct. 5, 2017

(54) CENTRALIZED SCHOOL ADMISSION APPLICATION AND DATA EXCHANGE SYSTEM AND PROCESS

(71) Applicant: Jennifer Harrell, Dallas, TX (US)

(72) Inventor: Jennifer Harrell, Dallas, TX (US)

(21) Appl. No.: 15/476,396

(22) Filed: Mar. 31, 2017

Related U.S. Application Data
(60) Provisional application No. 62/317,127, filed on Apr. 1, 2016.

(51) Int. Cl. G06Q 50/20; G06F 21/62; H04W 12/08; G06Q 10/06

(52) U.S. Cl. CPC G06Q 50/2053; G06Q 10/06; G06F 21/6245; H04W 12/08

(57) ABSTRACT

Systems and methods providing centralized admission application management, processing, control, and data exchanges for authorized users. A server or cloud-based system accessible from clients over a data network provides a universal application form, receives supplemental information in association with a student application, and authenticates and grants third party users and their access to records and forms associated with the applicant and provide additional information or records in support of the applicant's application to prospective schools. The system registers applicants, schools, and teachers as users, enables access to forms and data associated with applicant applications for admission to prospective schools, receives applicant information into a universal application form from which prospective schools can retrieve information associated with applicants, receives evaluation forms from teachers, provides application information and supplemental information to prospective schools, and authenticates and grants third party access to information associated applicants.

### CROSS REFERENCE TO RELATED APPLICATIONS

This patent application claims the priority and benefit under 35 U.S.C. §119(e) of U.S. Provisional Patent Application Ser. No. 62/317,127, filed on Apr. 1, 2016, and entitled “CENTRALIZED SCHOOL ADMISSION APPLICATION AND DATA EXCHANGE SYSTEM AND PROCESS,” which is incorporated herein by reference in its entirety.

### FIELD OF THE INVENTION

The present invention is generally related to centralized data processing, user access/authentication, and data access and control. More particularly, the present invention is related to systems and methods for providing centralized admission application management, processing, control, and exchanges for authorized users.

### BACKGROUND

The school admission process can be incredibly burdensome for applicants. Admissions to private schools in particular, whether they are at the K-12 or college level, often require more than a simple paper application from student applicants. Many applications require the submission of supplemental information/data with an application form, including recommendations from third parties (e.g., teachers, employers, counselors, coaches, etc.), transcripts of grades, and personal statements. To make matters more complex, applicants to several schools often have to repeat the application form and, supplemental data submission process as many times as the number of school to which they are applying. The foregoing is simply what is conventional in the field of school admissions.

What is needed is a more efficient system and process for applicants, as well as third parties supporting applicants, by significantly improving upon conventional systems and methods that are available to participants engagement in providing applications and data managing applications and data, and deciding school admissions.

### SUMMARY OF THE EMBODIMENTS

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

The present inventor hereby discloses many features believed to overcome the current problems associated with current school admission processes. Accordingly, it is a feature of the present invention to provide a system that can register users, collect data, process data, authorize access to the exchange, or provision of data to requesting users, and essentially streamline the school admission process. It is yet another feature of the present invention to provide processes utilizing a system that enables the registration of users, collection of data, processing of data, authorization of data and system access for the exchange or provision of data from/to requesting users, and essentially streamlines the school admission process with significantly more in the form of system and process improvements than what had been convention in the field as of the priority date of the present embodiments.

In accordance with an example embodiment, a network accessible server is provided that is configured to register users, collect data, process data, authorize access to the exchange or provision of data to requesting users, and essentially streamline the school admission process.

In accordance with yet another example of features for the embodiments, the network accessible server can register three different types of users: schools (both current and prospective), students/parents (applicant family), and teachers. It can be appreciated following the teaching herein that other users/third parties can be given access to the system/server, including coaches, ministers, counselors, employers, etc., with the permission of the applicant family.

It is yet another feature of the present invention that the system can enable any of the following features:
Create a profile page after the initial log-in/registration.
Identify initial/update school list.
Publish request data and application submission deadlines (e.g., can be associate with selected schools).
Complete a universal application with data that can be accessed by multiple schools all at once or individually.
Create a resume that will be saved in an applicant's (student's) profile and can be referenced by teachers and schools.
Electronically complete records release forms, giving an applicant's current school or other parties permission to upload the applicant's transcript via the system into an applicant's student profile.
Enable authorized upload of data, e.g., transcripts, into a student's profile, which can then be accessed by authorized parties including the school(s) to which the applicant is applying.
Complete evaluation/recommendation forms that will be uploaded to the applicant's profile.
Upload evaluation/recommendation forms electronically to the applicant's profile.
Receive updates on applicant's application status and run reports based on various fields.
Request teacher or other third party recommendations.
Provide access to a student's resume and data.
Complete supplemental forms requested, by prospective schools and save them to an applicant's user profile.
Process billing statements and payments associated with fees for school applications submitted by applicant.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a schematic diagram of an example embodiment of an environment in which a system for carrying out the embodiments including systems and methods for providing centralized admission application management, processing, control, and exchanges for authorized users;

FIG. 2 illustrates a block diagram of example modules for a system in accordance with features of the embodiments;

FIG. 3 illustrates a flow diagram for a process relevant to schools, in accordance with features of the embodiments;

FIG. 4 illustrates a flow diagram for a process relevant to student users, in accordance with features of the embodiments; and

FIG. 5 illustrates a flow diagram for a process relevant to teachers, in accordance with features of the embodiments.

### DETAILED DESCRIPTION OF EMBODIMENTS

Subject matter will now be described more fully hereinafter with reference to the accompanying drawings, which form a part hereof, and which show, by way of illustration, specific example embodiments. Subject, matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment, and the phrase “in another embodiment' as used herein does not necessarily refer to a different embodiment. It is intended, for example, that claimed subject matter include combinations of example embodiments in whole or in part.

In general, terminology may be understood, at least in part, from usage in context. For example, terms such as “and,” “or,” or “and/or” as used herein may include a variety of meanings that may depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context. The terms “student” and “applicant” may be used interchangeably throughout the specification.

Embodiment of the present invention boasts a centralized application process that streamlines the elementary, middle, and high school admission process. A centralized application allows all users (student families, schools, and teachers) to exchange information and documentation without the need for canning or sending via postal mail.

Embodiment of the present invention substantially improves on what is conventional and offers a single, unified application that dramatically simplifies the application process for parents and students who are applying to private, parochial, specialized (e.g., magnet) schools and academies. The application contains all of the pertinent biological, geographical, and academic information required for admissions while supplements submitted by each school can be customized for elementary school, middle school, and high schools to reflect the appropriate information needed for each specific entry point. This allows for seamless integration across a campus and with existing information systems.

Embodiment of the present invention offers users the ability to enter and store a student's application information on cloud servers and then easily share it with selected public, private, and parochial schools.

Features of the embodiments can offer increased analytics and data driven insights into the application process and the applicant pool based on various applicant traits such as grade point average, geographic location, extracurricular participation, parent/guardian professional career, and more giving the schools access to data that is presented clearly and can be shared with other individuals involved in the admission process.

Schools have historically had very little access to real time data regarding the application/enrollment process. Features of the embodiments provided as a system or application can be referred to as “Ideal Admissions” and can allow schools to identify trends (demographic and geographic enrollment trends, engagement metrics, etc.) that can also help the schools make strategic decisions that may impact areas such as staffing, operations, etc. Features of the embodiments can enable the collection of this information and allow school administrators to quickly and easily view data associated to applicants.

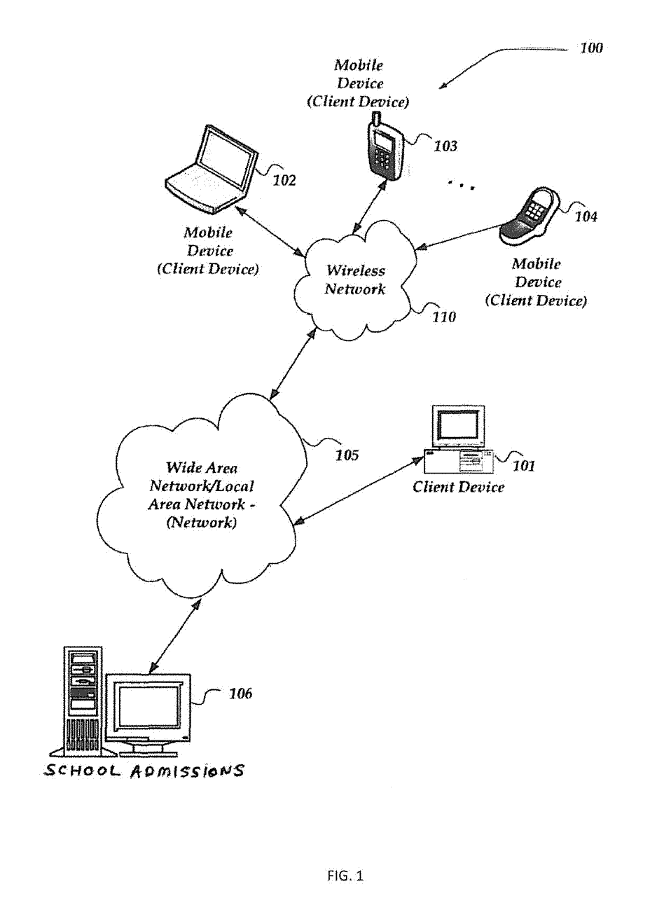

FIG. 1 illustrates a schematic diagram depicting an example embodiment of a system 100 composed of one or more networks. System 100 is an example of an environment in which a system for mapping notable entities to their social profiles, as described in greater detail herein, may operate. Other embodiments that may vary, for example, in terms of arrangement or in terms of type of components, are also intended to be included within the claimed subject matter. The system 100 depicted in FIG. 1, for example, can include a variety of networks, such as a WAN (Wide Area Network)/LAN (Local Area Network) 105, a wireless network 110, and a variety of devices, such as a client device 101 and mobile devices 102, 103, 104, and a variety of servers, such as school admissions server (SAS) 106. Server 106 can also he representative cloud-based services. In the example configuration depicted in FIG. 1, mobile devices 102, 103, and 104 are client devices that communicate wirelessly with system 100 through the wireless network 110. The WAN/LAN network 105 also communicates with the wireless network 110.

A server, such as school admission server 106, may include a device that includes a configuration to receive, process, and provide school application related data via a network to another device. A SAS server 106 may, for example, host a website and can enable secure log-in functionality for users to engage with and provide/receive data from the server.

A network such as network 105 and/or network 110 depicted in FIG. 1 can couple devices so that communications and data may be exchanged, such as between a server 106 and a client device 101 or other types of devices, including between wireless devices 103/104 coupled via a wired or wireless network 110, for example. A network may also include mass storage, such as network-attached storage (NAS), a storage area network (SAN), or other forms of computer or machine-readable media, for example. A network may include the Internet, one or more Local Area Networks (LANs), one or more Wide Area Networks (WANs), wire-line type connections, wireless type connections, or any combination thereof. Likewise, sub-networks may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices can be remotely coupled to a network, such as via a telephone line or link, for example.

A wireless network such as the wireless network 110 depicted in FIG. 1 may couple client devices with the network. That is, such a wireless network may employ stand-alone ad-hoc networks, mesh networks, wireless LAN (WLAN) networks, cellular networks, or the like. A wireless network such as wireless network 110 can further include a system of terminals, gateways, routers, or the like coupled by wireless radio links, or the like, which may move freely, randomly, or organize themselves arbitrarily, such that network topology may change, at times even rapidly. A wireless network may further employ a plurality of network access technologies, including Long Term Evolution (LTE), WLAN, Wireless Router (WR) mesh, or 2nd, 3rd, or 4th generation (2G, 3G, 4G, 5G, an so on) cellular technology, or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS), General Packet Radio Services (CPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

Signal packets communicated via a network, such as a network of participating digital communication networks (e.g., networks 105, 110) may be compatible with or compliant with one or more protocols. The signaling formats or protocols employed may include, for example, TCP/IP, UDP, DECnet, NetBEUI, IPX, AppleTalk, or the like. Versions of the Internet Protocol (IP) may include IPv4 or IPv6.

The Internet refers to a decentralized global network of networks. The Internet includes Local Area Networks (LANs), Wide Area Networks (WANs), wireless networks, or long haul public networks that, for example, allow signal packets to be communicated between LANs. Signal packets may be communicated between nodes of a network, such as, for example, to one or more sites employing a local network address. A signal packet may, for example, be communicated over the Internet from a user site via an access node coupled to the Internet. Likewise, a signal packet may be forwarded via network nodes to a target site coupled to the network via a network access node, for example. A signal packet communicated via the Internet may, for example, be routed via a path of gateways, servers, etc., that may route the signal packet in accordance with a target address and availability of a network path to the target address.

A website ire accordance with embodiments of the present invention can function in or with school admission server 106 programmed with specialized features to enable feature of the embodiments and allow for three separate user-types to log in: schools (both current and prospective), students/parents (applicant family), and teachers.

Schools:
An applicant's current school will have independent log-in credentials and the following capabilities:
Upload transcripts to the applicant's profile, which can then be accessed by the school to which the applicant is applying.
Counselors or principals can complete evaluation forms that will be uploaded to the student's profile.
Receive updates on their applicants' application status and run reports based on various fields.
The prospective schools to which applicants are applying will have independent log-in credentials and the following capabilities:
   Upload documents such as supplemental forms to be completed by applicant families.
   Publish deadlines for submitting/completing applications.
   Retrieve documentation from an applicant's profile.
   Access transcripts from an applicant's profile.
   Run reports based on various fields.

Students:
Students (applicant families) will have independent log-in credentials and the following capabilities:
Complete the Ideal Application and at their request, this single application can be accessed by multiple schools all at once, or individually. Each time a school is chosen, a payment will be processed.
Electronically complete a records release form which will give their current school permission to upload their transcript via Ideal Admissions to their student profile.
Request teacher recommendations via Ideal Admissions.
Pay each school's application fee through Ideal Admissions, and this can be done all at once, or separately, if needed.
Create a resume that will be saved in their profile and referenced by teachers and schools.
Complete supplemental forms requested by prospective schools and save them to their profile.

Teachers:
Teachers will have independent log-in credentials and the following capabilities:
Create a profile page after the initial log-in.
Publish request deadlines.
Upload recommendation forms electronically to the applicant's profile.
Access an applicant's resume via Ideal Admissions.

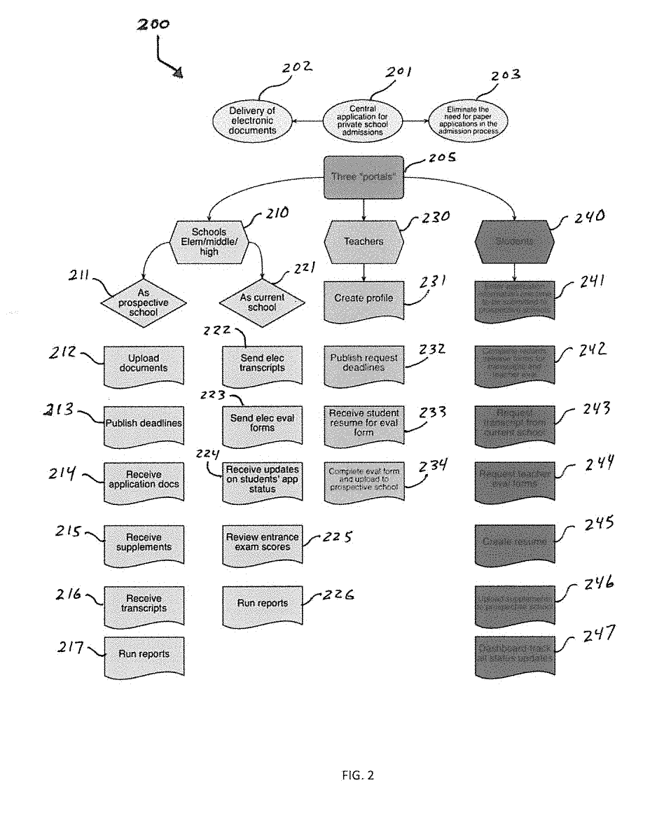

Referring to FIG. 2, a block diagram 200 of example modules for a system that can be embodied as programming within a server 106 to enable specialized features associated with the embodiments, in accordance with features of the embodiments is illustrated. A central application for private school admissions 201 can support the delivery of electronic documents 202 to authorized (e.g., registered) users, and eliminate the need for paper application in the school admission process 203. Three portals 205 can be provided: school 210, teachers 230, and students 240. The school portal 210 can integrate with prospective schools 211 and enable the upload of documents 212, publishing of deadlines 213, receipt of application documents 214, receipt of supplemental information 215, receipt of transcripts 216, and run reports 217. Integration with a current school 221 can enable sending of transcripts 222 to requesting parties (e.g., prospective schools), sending of evaluation forms 223, receipt of updates on a student's application 224, enable review of entrance exam scores 225, and run reports 226. A teachers' portal 230 can enable profile creation 231, publishing of request deadlines 232, receipt of student résumé (and other materials) for evaluation forms 233, and completion of evaluation forms 234. The student portal 240 can enable the student user to enter information one time into a universal application form 241 for use in submission of application data to prospective schools, completion of records release forms for transcripts and teacher evaluations 242, enable the request of transcript from the user's current school 243, request teacher evaluation forms 244, create résumés 245, upload supplemental information for prospective schools 246, and provide a dashboard to track status and receive updates 247.

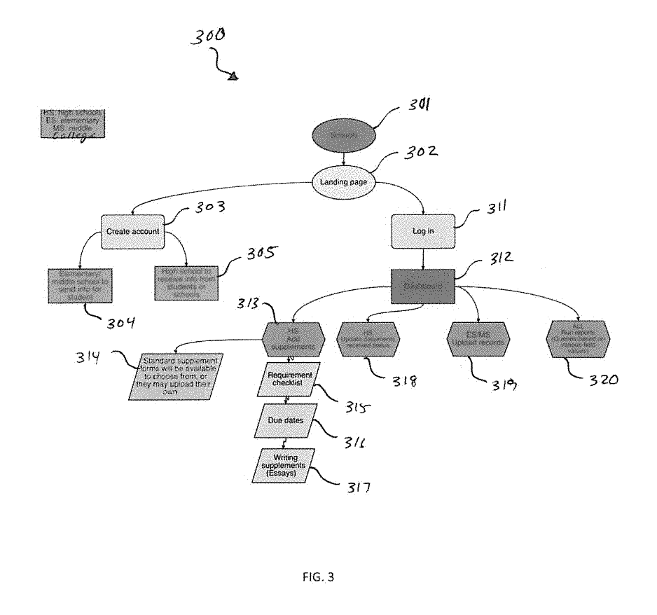

FIG. 3 illustrates a flow diagram 300 for a process relevant to schools 301 (e.g., high/prep schools, colleges, universities), in accordance with features of the embodiments. A school user can initially interface with a server embodying features supporting a universal application via a landing page 302, typically represented by a website homepage. From the landing page, the school user can create a new account 303 (unless an account has been provided to the user, then proceed to log in 311). In the case of high school admission process where lower level schools are registering to provide information to prospective high schools on behalf of students, as an example, the school user will set up the account with its identifying information as shown in block 304. As shown in block 305, a high school receiving data related to an applying student (or students) also registers with the system by providing information to receive student and school information associated with applying students. Once registered, users can log in as shown in block 311. Once logged in, a user can be directed to a dashboard 312 wherein it can add/receive supplemental information 313, provide/receive a requirement checklist 315, establish or become informed of due dates 316, and provide or obtain writing supplements (essays) 317. Schools providing or awaiting updated information can receive updates 318. Schools can upload records 319. Reports can also be rendered for users based on queries 320.

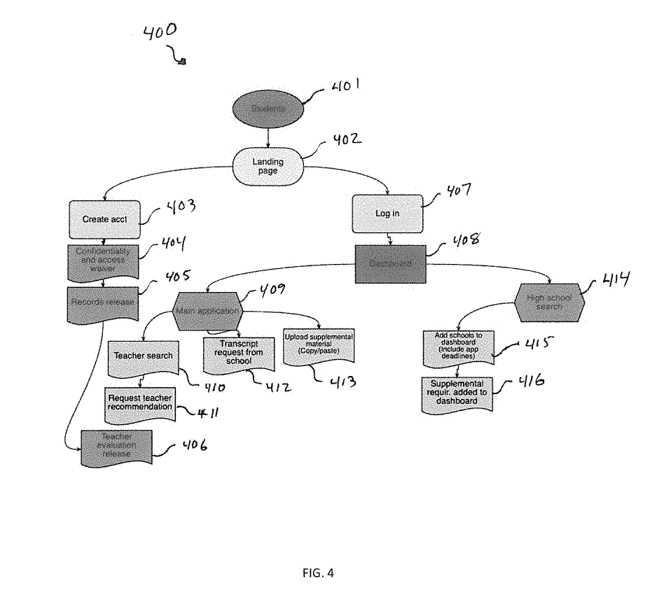

FIG. 4 illustrates a flow diagram 400 for a process relevant to student users 401 in accordance with features of the embodiments. Student users 401 can initially encounter a landing page 402 wherefrom the student user can create an account 403, prepare confidentiality and access waivers for third parties the user wants to grant with access to the user's records, as shown in Block 404, and provide record releases 405 to third parties (e.g., teachers, schools, etc.). Releases can include teacher evaluation releases 406. If already registered, the student user 401 can log in 407, whereafter the user can encounter a dashboard 408 wherefrom the user can work on application material 409 or search for prospective schools 414 (e.g., “high school search”). Under the main application module 409, the user can search for teachers 410, request teacher recommendations 411, request transcripts 412, and upload supplemental material 413. If using the search module 414, the user can add schools to the user's dashboard 408 (including deadlines for the prospective schools) and add supplemental requirements from new schools of interest to the user's dashboard.

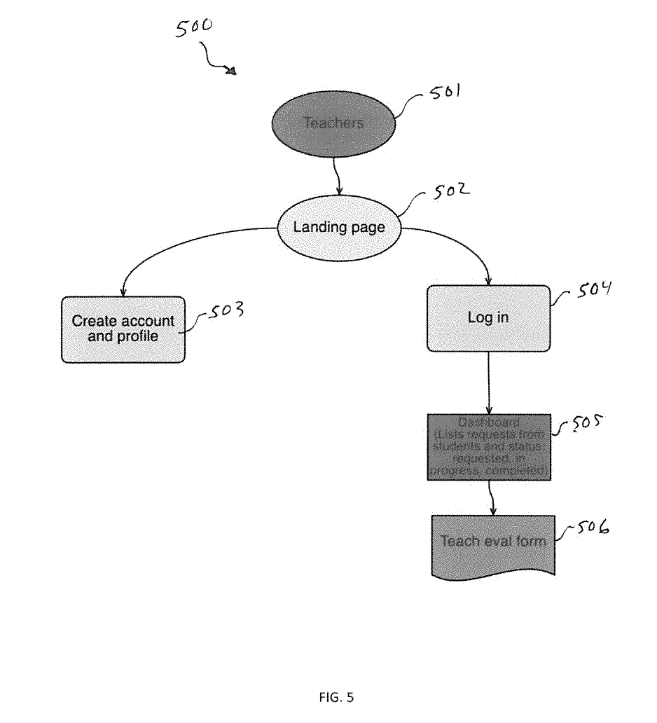

FIG. 5 illustrates a flow diagram 500 for a process relevant to teachers 501, in accordance with features of the embodiments. As with the school and student users, a teacher 501 can encounter a landing page 502 wherefrom the teacher can create an account and profile 503 as an initial account set up procedure, or can log in 504 if already a registered user. Once logged in, the teacher can access a dashboard 505, wherein lists of requests from students, requests status, profess, and completed information can be provided. The teacher can also access and complete teacher evaluation forms 506.

It is another feature of the embodiments that intelligence for providing school recommendation to applications can be provided via processing in a server based on a students profile data and school selections. “Recommended School Intelligence” can be based on an assessment of the primary school (or schools) to which a parent/student is applying together with a student's profile data (e.g., as provided in the application or submitted supplemental information), wherefrom the system can recommend additional schools that are similar in terms of size, focus, cost, and/or proximity to the user. This insight will allow more choices for the parents/students in the application process. For example, if a student is applying to ABC School, then the student (or parents) should be able to consider looking at XYZ School because it is any of: the same focus, similar cost, or only 2 miles away from the student residence. Machine learning and artificial intelligence can be incorporated into a server or cloud based system to provide the analytics to render such recommendations. Over time, an intelligent system can learn from all applicant submitted data to determine optimum recommendations to students. For example, if the system can determine that 90% of students who accepted at ABC are also accepted at XYZ, it can indicate that XYZ is another option for the student. Furthermore, a system can learn that DEF School is searching, for a markedly different student body and applicants and has higher (or lower) standards, therefore based on what we the system knows about this the applicant it may not recommend application to DEF School.

1. A system for providing centralized admission application management, processing, control, and exchanges for authorized users, comprising:
a server including data network access to remote clients and accessible from the remote clients over the data network, the server programmed to:
register applicants for access to the system;
provide a universal application form to applicants that can be filled in with information from the applicants, stored and then the information can be provided into diverse applications association with different schools;
receive supplemental information in association with information from applicants provided on the universal application form; and
authenticate and grant access to records including universal application forms and supplemental information associated with the applicants based on stored information associated with applicants to third parties authorized by the applicants to gain access and retrieve records in support of the applicants' application to prospective schools represented by the third parties.

2. The system of claim 1, wherein the remote clients include at least one of: a smartphone, a laptop, or a desktop computer, and the remote clients communicate with the server via at least one of: Wi-Fi, mobile cellular communications, wide area network communications, and local area network communications.

3. The system of claim 1, wherein the remote clients are authorized to communicate with the server via the step to authenticate and grant access to records including universal application forms and supplemental information associated with the applicants based on stored information associated with applicants to third parties authorized by the applicants to gain access and retrieve records in support of the applicants' application to prospective schools represented by the third parties.

4. The system of claim 1, wherein the supplemental information includes at least one of: entrance exam scores, transcripts, evaluation forms, letter of recommendation, and résumés.

5. The system of claim 2, wherein the remote clients are authorized to communicate with the server via the step to authenticate and grant access to records including universal application forms and supplemental information associated with the applicants based on stored information associated with applicants to third parties authorized by the applicants to gain access and retrieve records in support of the applicants' application to prospective schools represented by the third parties.

6. The system of claim 5, wherein the remote client access the supplemental information and the supplemental information includes at least one of: entrance exam scores, transcripts, evaluation forms, letter of recommendation, and résumés.

7. The system of claim 3, wherein the remote clients include at least one of: a smartphone, a laptop, or a desktop computer, and the remote clients communicate with the server via at least one of: Wi-Fi, mobile cellular communications, wide area network communications, and local area network communications.

8. The system of claim 7, wherein the remote clients access the supplemental information and the supplemental information includes at least one of: entrance exam scores, transcripts, evaluation forms, letter of recommendation, and résumés.

9. A method for providing centralized admission application management, processing, control, and exchanges for authorized users, comprising:
providing a server, including data network access to remote clients and accessible from the remote clients over the data network, programmed to register applicants for access to the system and set up a profile for the applicants, provide a universal application form to applicants that can be filled in with information from the applicants, stored and then the information can be provided into diverse applications association with different schools, receive supplemental information in association with information, from applicants provided on the universal application form, and authenticate and grant access to records including universal application forms and supplemental information associated with the applicants based on stored information associated with applicants to third parties authorized by the applicants to gain access and retrieve records in support of the applicants' application to prospective schools represented by the third parties;
registering applicant, school, and teacher users with at the server;
receiving student information into a universal application form from which prospective schools can retrieve information associated with applicants including the student;
enabling a student user to grant school users and teacher users with access to information from the universal application forms and the supplemental information associated with the student in support of the applicant's application for admission to prospective schools;
receiving evaluation forms from teachers associated with the applicant and provided with teacher user access by the applicant;
enabling a student user to select and authorize prospective schools to receive the application information and supplemental information;
providing application information, evaluation information, and supplemental information in association with the applicant to the prospective schools selected and authorized by the applicant to receive the application information and supplemental information; and
authenticating and granting access to records and forms associated with the applicant to third parties authorized by the student to access the server based on the applicant's profile and provide records in support of the applicant's application to prospective schools.

10. The method of claim 1, wherein the remote clients include at least one of: a smartphone, a laptop, or a desktop computer, and the remote clients communicate with the, server via at least one of: Wi-Fi, mobile cellular communications, wide area network communications, and local area network communications.

11. The method of claim 1, wherein the remote clients are authorized to communicate with the server via the step to authenticate and grant access to records including universal application forms and supplemental information associated with the applicants based on stored information associated with applicants to third parties authorized by the applicants to gain access and retrieve records in support of the applicants' application to prospective schools represented by the third parties.

12. The method of claim 1, wherein the supplemental information includes at least one of: entrance exam scores, transcripts, evaluation forms, letter of recommendation, and résumés.

13. The method of claim 10, wherein the remote clients are authorized to communicate with the server via the step to authenticate and grant access to records including universal application forms and supplemental information associated with the applicants based on stored information associated with applicants to third parties authorized by the applicants to gain access and retrieve records in support of the applicants' application to prospective schools represented by the third parties.

14. The system of claim 13, wherein the remote clients access the supplemental information and the supplemental information includes at least one of: entrance exam scores, transcripts, evaluation forms, letter of recommendation, and résumés.

15. The system of claim 11, wherein the remote clients include at least one of: a smartphone, a laptop, or a desktop computer, and the remote clients communicate with the server via at least one of: Wi-Fi, mobile cellular communications, wide area network communications, and local area network communications.

16. The system of claim 15, wherein the remote clients access the supplemental information and the supplemental information includes at least one of: entrance exam scores, transcripts, evaluation forms, letter of recommendation, and résumés.

17. A school admission system providing centralized admission application management, processing, control, and exchanges for authorized users, comprising:
a server including data network access to remote clients and accessible from the remote clients over the data network, the server programmed to:
create three portals including an applicant portal, a school portal, and a teacher portal;
register applicants for access to the system via the applicant portal;
provide a universal application form to applicants that can be filled in with information from the applicants, stored, and then the information can be provided into diverse applications association with different schools;
receive supplemental information in association with information from applicants provided on the universal application form;
authenticate and grant access to records including universal application forms, and supplemental information associated with the applicants based on stored information associated with applicants to third parties authorized by the applicants to gain access and retrieve records in support of the applicants' application to prospective schools represented by the third parties; and
at least one client accessing the system via at least one of the student portal, the school portal, and the teacher portal.

18. The method of claim 17, wherein the remote clients include at least one of: a smartphone, a laptop, or a desktop computer, and the remote clients communicate with the server via at least one of: Wi-Fi, mobile cellular communications, wide area network communications, and local area network communications, and the remote clients are authorized to communicate with the server via the step to authenticate and grant access to records including universal application forms and supplemental information associated with the applicants based on stored information associated with applicants to third parties authorized by the applicants to gain access and retrieve records in support of the applicants' application to prospective schools represented by the third parties.

19. The method of claim 17, wherein the supplemental information includes at least one of: entrance exam scores, transcripts, evaluation forms, letter of recommendation, and résumés.

20. The system of claim 18, wherein the remote clients access the supplemental information and the supplemental information includes at least one of: entrance exam scores, transcripts, evaluation forms, letter of recommendation, and résumés.
